(19) United States
(12) Patent Application Publication
(10) Pub. No.: US 2012/0126970 A1
(43) Pub. Date: May 24, 2012

(54) LAMP SET FOR HOLDING A FIRE EXTINGUISHER

(76) Inventor: Yu-Ching HSU, Hsinchu City (TW)

(21) Appl. No.: 13/301,243

(22) Filed: Nov. 21, 2011

(30) Foreign Application Priority Data
Nov. 22, 2010 (TW) 99222623

(51) Int. Cl. G08B 19/00; G08B 1/08; G08B 21/00

(52) U.S. Cl. 340/521; 340/666; 340/539.1

(57) ABSTRACT

A lamp set capable of holding a fire extinguisher includes a light emission module, an audio module, an electric storage device to provide electric power for the light emission module and the audio module, a hollow pillar to hold the fire extinguisher, and a gravity sensor to detect whether the fire extinguisher is held in the hollow pillar. When the gravity sensor detects the fire extinguisher is separated from the hollow pillar, the audio module is activated to generate sound effect for alarming.

### FIELD OF THE INVENTION

The present invention relates to a lamp set and particularly to a lamp set capable of holding a fire extinguisher.

### BACKGROUND OF THE INVENTION

Fire accidents happen frequently in many places in recent years that cause significant loss of life or injury of people and great amount of financial losses. They are serious problems that cannot be overlooked. At present many people usually put fire extinguishers at non-conspicuous locations due to aesthetic consideration. Their effective periods often are being neglected and become unusable. Some of them are blocked by other piled miscellaneous articles and not readily usable. Hence when fire breakout takes place trying to fetch them is quite difficult or not very helpful. A small fire could quickly be out of control and rampage into conflagration.

### SUMMARY OF THE INVENTION

The primary object of the present invention is to provide a lamp set capable of holding a fire extinguisher.

The lamp set according to the invention includes a light emission module, an audio module, an electric storage device to provide electric power for the light emission module and audio module, a hollow pillar to hold a fire extinguisher, and a gravity sensor to detect whether the fire extinguisher is held in the hollow pillar. When the gravity sensor detects that the fire extinguisher is separated from the hollow pillar, it activates the audio module to generate sound effect for alarming.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a first embodiment of the invention.

FIG. 2 is a perspective view of a second embodiment of the invention.

FIG. 3 is a perspective view of a third embodiment of the invention.

FIG. 4 is a sectional view of a fourth embodiment of the invention.

### DETAILED DESCRIPTION OF THE PREFERRED EMBODIMENTS

A lamp set usually is located at an obvious position and can provide illumination without being blocked by other miscellaneous articles. Hence the present invention aims to provide a lamp set capable of holding a fire extinguisher that, in addition to providing illumination, also can hold a fire extinguisher so that the fire extinguisher is readily usable to facilitate fire extinguishing, and also is incorporated with an audio module to generate sound effect for alarming in the event that a fire accident occurs.

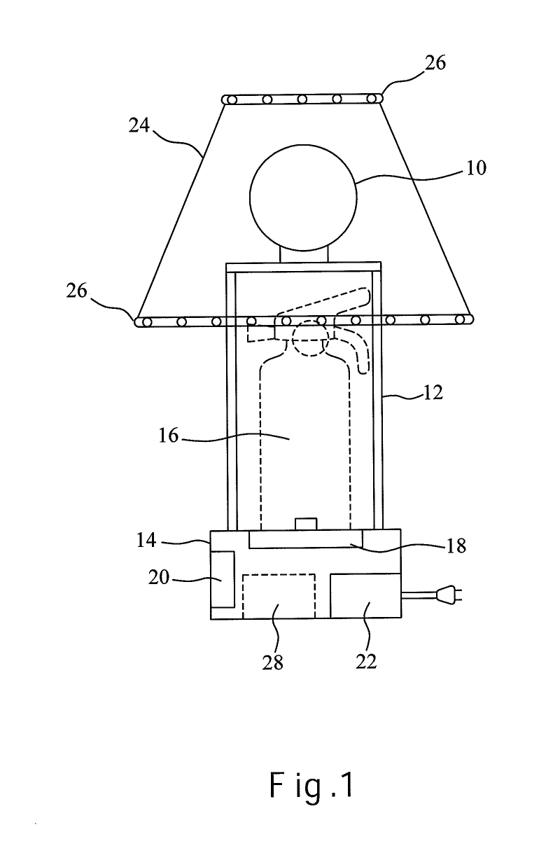

Please refer to FIG. 1 for a first embodiment of the invention. The lamp set in this embodiment includes a light bulb 10, a hollow pillar 12 and a base 14. The light bulb 10 is adjustable to dim and intensify light illumination. The hollow pillar 12 aims to hold fire fighting equipment, such as a fire extinguisher 16. The base 14 has a gravity sensor 18 to detect whether the fire extinguisher 16 is held in the hollow pillar 12. When a fire accident happens and a user takes out the fire extinguisher 16 from the hollow pillar 12, the gravity sensor 18 in the base 14 activates an audio module 20 because of the loss of weight of the fire extinguisher 16 to generate sound, such as buzz from a buzzer, and alert other people of the fire accident so that they can have enough time to escape from the on fire place. Take into account of the fire extinguisher 16 could lose weight due to leaking of the contents inside that might impact fire extinguishing efficacy, a threshold value can be set so that when the weight of the fire extinguisher 16 is lower than the threshold value the fire extinguisher 16 is deemed not meeting standard, and the content of the fire extinguisher 16 has to be replenished, or the fire extinguisher 16 has to be replaced. The base 14, aside from holding the gravity sensor 18 and audio module 20, also includes an electric storage device 22. When commercial power is supplied normally, the light bulb 10 and audio module 20 are powered by the commercial power, and the electric storage device 22 stores electric power and is electrically connected to the light bulb 10 and audio module 20. In the event that the commercial power is broken off, the electric storage device 22 continuously supplies electric power to the light bulb 10 and audio module 20. Preferably, in the event that commercial power is broken off, the light bulb 10 is activated to serve as emergency light. If necessary, different lighting modules can be added to provide functions different from the light bulb 10. For instance, in FIG. 1, a LED lamp string 26 is installed on a lamp shade 24 to provide illuminating function different from the light bulb 10. The LED lamp string 26 can include LED lamps of different colors for ornamental purpose. Preferably, the LED lamp string 26 also can be adjusted to dim or intensify light illumination.

In one aspect, the base 14 also can include different ancillary detection devices 28 that are electrically connected to the audio module 20 to provide different functions. For instance, the ancillary detection device 28 could be a dangerous gas detector to detect dangerous gas such as carbon monoxide, smoke generated by fire accident or the like. In the event that the ancillary detection device 28 detects the concentration of the dangerous gas exceeding a set threshold value, the audio module 20 is activated to generate sound effect for alarming. The ancillary detection device 28 may also be a temperature detector. In the event that temperature over a set threshold is detected, the audio module 20 is activated to generated audio alarm. The ancillary detection device 28 may also be a laser infrared sensor to provide laser beam on the route such as a door, window or the like where intruders could possibly pass through. In the event that the ancillary detection device 28 detects interruption of the laser beam, the audio module 20 is activated to generate sound effect for alarming. In all the situations mentioned above, the light bulb 10 may also be controlled to flicker for warning.

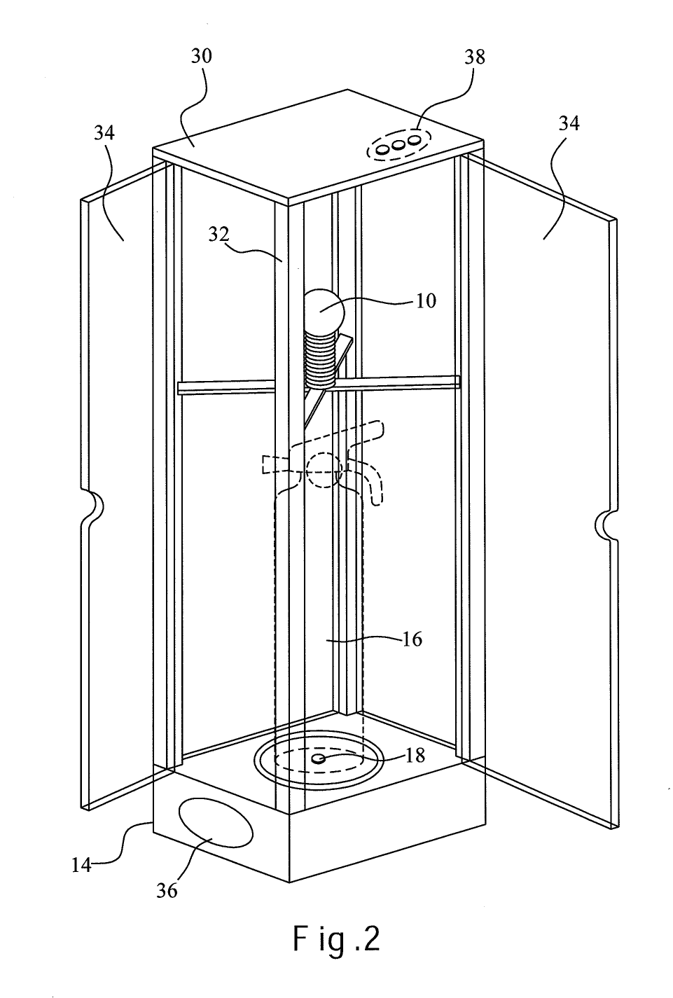

FIG. 2 illustrates a second embodiment of the invention in which the hollow pillar 30 includes a frame 32 and light permeable panels 34. To facilitate fetching of the fire extinguisher 16, the light permeable panels 34 and frame 32 are hinged on the base 14 to become movable doors. The light bulb 10 is held in the hollow pillar 30, so that the light can project through the light permeable panels 34. Preferably, the light permeable panels 34 can be replaceable with different colors. In other embodiments, the movable doors can be opaque, but may have hollow-out openings so that light from the light bulb can pass through the hollow pillar 30. The same as FIG. 1, the base 14 also has a gravity sensor 18, an electric storage device (not shown in the drawings) and an audio module (neither not shown in the drawings). The base 14 also has an audio outlet 36 to broadcast the sound generated by the audio module. In addition, this embodiment further has a control module 38 which is electrically connected to the light bulb 10 and audio module. The control module 38 includes buttons to adjust light intensity of the light bulb 10 and sound volume of the audio module and operation mode. Preferably, the audio module includes an audio file decoder to decode audio files of audio players such as MP3. In another aspect the audio module can include radio receiver function to receive AM/FM broadcasting. In yet another aspect, the audio module includes an audio connection port to receive audio signals from a handset, audio player or the like and play, or output the sound effect via the audio connection port to an external audio amplifier. In other embodiments, a timer module can be provided to give time and set a specific time so that the audio module can be activated to generate desired sound effect at the specific time.

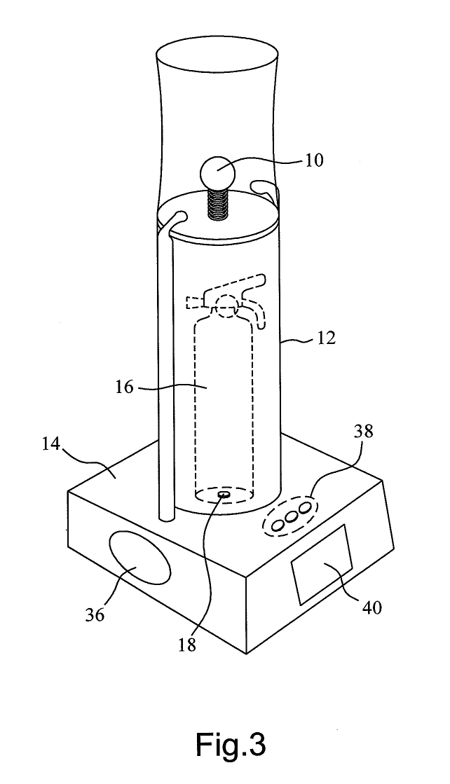

Please refer to FIG. 3 for a third embodiment of the invention. It includes a light bulb 10, a hollow pillar 12 and a base 14 same as FIG. 1. The base 14 also includes a gravity sensor 18, an audio module (not shown in the drawings) and an electric storage device (neither not shown in the drawings). When the fire extinguisher 16 is separated from the hollow pillar 12 or when the weight of the fire extinguisher 16 does not meet the standard, the audio module (not shown in the drawings) in the base 14 is activated to generate sound through an audio outlet 36. In addition, the base 14 also has a control module 38 and a display device 40. The control module 38 not only can adjust light intensity of the light bulb 10 and sound effect volume of the audio module and operation mode thereof, but also can control the display device 40 to display required information by users, such as time, temperature, use instruction, fire fighting equipment layout or escape routes and the like. In one aspect, the display device 40 includes an image file decoder to broadcast image files, such as jpg, gif, avi and the like. In another aspect, the display device 40 includes an image connection port to receive image signals from a handset, portable player, monitor or the like and display thereon. In yet another aspect, the functions of the control module 38 and display device 40 can be integrated through a touch display. In another aspect, the control module 38 is equipped with a wireless communication function to allow users to issue a control signal from a remote site to control the lamp set of the invention.

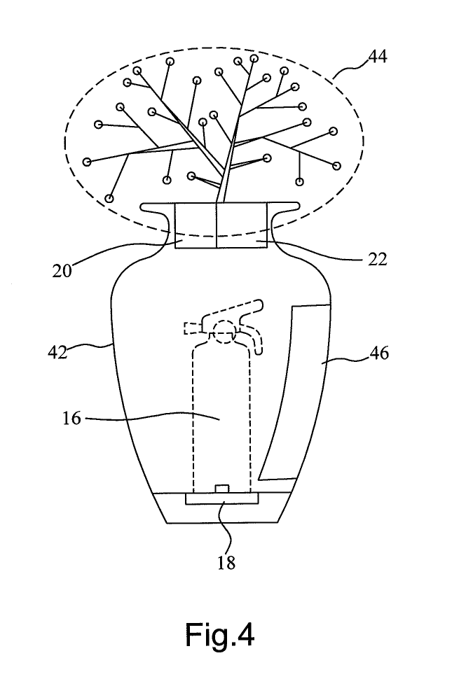

FIG. 4 illustrates a fourth embodiment of the invention. The hollow pillar 42 is a flower vase to hold a light emission module 44 formed by iron wires and LEDs to provide ornamental effect. In one aspect, the LEDs of a higher luminosity can increase brightness of the light emission module 44. The fire extinguisher 16 is held in the vase-shaped hollow pillar 42. The hollow pillar 42 also has a gravity sensor 18 at the bottom to detect the condition of the fire extinguisher 16, and an audio device 20 and an electric storage device 22 connected with the light emission module 44. In one aspect, the vase-shaped hollow pillar 42 has a movable door 46 at one side to facilitate fetching of the fire extinguisher 16.

Moreover, the lamp set according to the invention may also be hand-held with the electric storage device providing electric power required for illumination. The electric storage device is detachable, and multiple sets can be provided to improve usability. In the event an outdoor activity needs fire, the invention can provide illumination and fire fighting function at the same time.

What is claimed is:

1. A lamp set for holding a fire extinguisher, comprising:
a light emission module;
an audio module;
an electric storage device electrically connected to the light emission module and the audio module to provide electric power needed thereof;
a hollow pillar to hold a fire extinguisher; and
a gravity sensor electrically connected to the audio module to detect whether the fire extinguisher is held in the hollow pillar and control the audio module to generate sound effect for alarming when detecting the fire extinguisher is separated from the hollow pillar.

2. The lamp set of claim 1, wherein light intensity of the light emission module is adjustable.

3. The lamp set of claim 1, wherein the light emission module is activated to serve as emergency light when commercial power is broken off.

4. The lamp set of claim 1, wherein the gravity sensor includes a threshold value so that when weight of the fire extinguisher is lower than the threshold value, the audio module is activated to generate the sound effect for alarming.

5. The lamp set of claim 1 further including an ancillary detection device which is electrically connected to the audio module to control the audio module to generate the sound effect for alarming.

6. The lamp set of claim 5, wherein the ancillary detection device is a dangerous gas detector to detect dangerous gas and control the audio module to generate the sound effect for alarming upon detecting the dangerous gas.

7. The lamp set of claim 5, wherein the ancillary detection device is a temperature detector to detect temperature and control the audio module to generate the sound effect for alarming upon detecting the temperature exceeding a set threshold value.

8. The lamp set of claim 5, wherein the ancillary detection device is a laser infrared sensor to detect laser beam and control the audio module to generate the sound effect for alarming upon detecting interruption of the laser beam.

9. The lamp set of claim 1, wherein the hollow pillar includes a movable door.

10. The lamp set of claim 1, wherein the light, emission module is located in the hollow pillar which is partially carved or made of a light permeable material to allow light generated from the light emission module to emit.

11. The lamp set of claim 1 further including a control module which is electrically connected to the light emission module and the audio module to control light intensity of the light emission module and sound effect volume of the audio module and operation mode thereof.

12. The lamp set of claim 11, wherein the control module is equipped with a wireless communication function.

13. The lamp set of claim 1, wherein the audio module includes an audio file decoder to decode audio files.

14. The lamp set of claim 1, wherein the audio module includes an audio connection port to receive or output audio signals.

15. The lamp set of claim 1 further including a display module which includes a display device to provide user information.

16. The lamp set of claim 15, wherein the user information includes time, temperature, use instruction, fire fighting equipment layout or escape routes.

17. The lamp set of claim 15, wherein the display device is a touch display.

18. The lamp set of claim 15, wherein the display module includes an image file decoder to decode image files and display on the display device.

19. The lamp set of claim 15, wherein the display module includes an image connection port to receive image signals and display on the display device.

20. The lamp set of claim 1, wherein the electric storage device is detachable.
